(19) United States
(12) Patent Application Publication
(10) Pub. No.: US 2009/0307651 A1
(43) Pub. Date: Dec. 10, 2009

(54) Computing Platform for Structured Data Processing

(76) Inventors: Shanmugam Senthil, Bangalore (IN); Alejandro Abdelnur, Bangalore (IN); Anis Ahmed S.K., Bangalore (IN); Ravikiran Meka, Raichur (IN); Ruchirbhai Rajendra Shah, Anand (IN); Karteek Jasti, Tenali (IN); Abhijit Bagri, Asansol (IN)

Correspondence Address: STATTLER - SUH PC, 60 SOUTH MARKET STREET, SUITE 480, SAN JOSE, CA, 95113, US

(21) Appl. No.: 12/133,965

(22) Filed: Jun. 5, 2008

(51) Int. Cl. G06F 9/44

(52) U.S. Cl. 717/102

(57) ABSTRACT

This patent discloses a computing platform to process structured data. The computer platform may include a component layer having a workflow engine to execute a workflow definition. The workflow engine may receive feed data from a user system. The workflow engine may send a business logic application and feed data to a distributed computation environment to batch process the feed data through the business logic application as part of executing the workflow definition.

### BACKGROUND

1. Field

The information disclosed in this patent relates to a computing platform to receive varied data. The computing platform may process that data for cooperative use by workflow definitions and work scheduling software.

2. Background Information

Many websites that host search engines also host structured content such as automobile listings, job postings, news feeds, and real estate listings. Websites receive this information from thousands of different sources of varying sizes. For example, the Yahoo! Real Estate website may receive 1,000,000+ listings each day from RealEstate.com and may receive millions more each day from hundreds of other companies.

The data received by the website may be arranged in a variety of ways that may not necessarily be compatible with the needs of the website. Before presenting this data live on the website, this data may be process to determine validity and compatibility with the structured framework of the website.

Stale data loses its business generating opportunities very quickly. Accordingly, companies hiring websites expect that their data will be processed and hosted live quickly, sometime within hours of receipt. What is needed is a system to address these and other issues.

### SUMMARY

This patent discloses a computing platform to process structured data. The computer platform may include a component layer having a workflow engine to execute a workflow definition. The workflow engine may receive feed data from a user system. The workflow engine may send a business logic application and feed data to a distributed computation environment to batch process the feed data through the business logic application as part of executing the workflow definition.

### BRIEF DESCRIPTION OF THE FIGURES

FIG. 1 is a block diagram illustrating a platform 100.

FIG. 2 is a block diagram illustrating details of platform 100.

FIG. 3 is a template 222 for a record processor business logic application 214 written in Java programming language.

FIG. 4 is an example of distributed computation environment 14 processing a data cleaning template 222 into multiple outputs.

FIG. 5 is a schematic 500 of workflow definition 212 being executed by workflow engine 308.

FIG. 6 is a data flow diagram illustrating a method 600 to process structured data in computing platform 100.

FIG. 7 is an example workflow definition 212.

FIG. 8 illustrates a network environment 700 for operation of platform 100.

### DETAILED DESCRIPTION

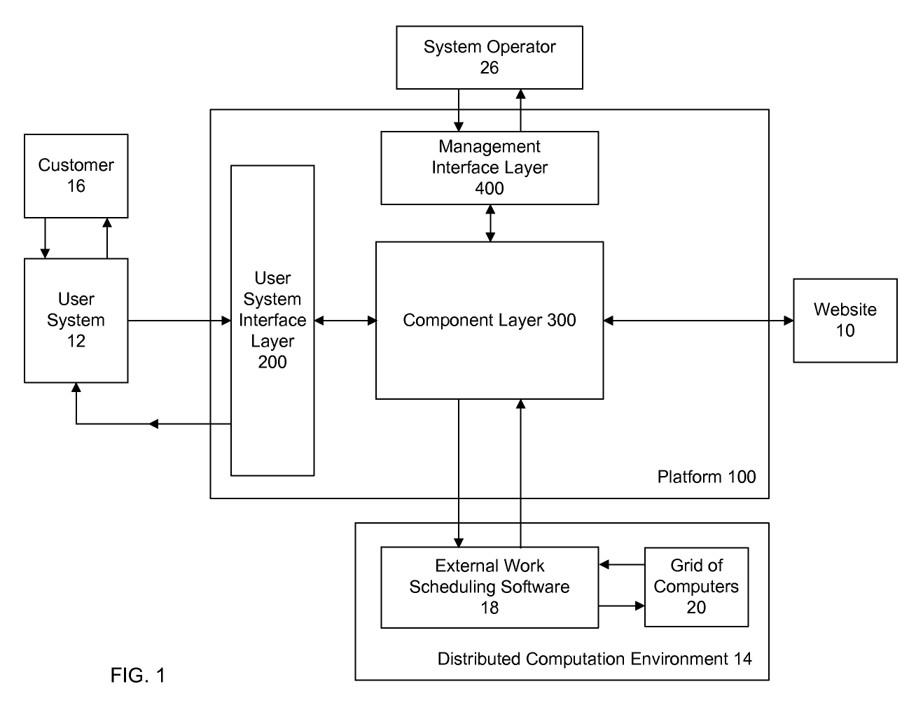

FIG. 1 is a block diagram illustrating a platform 100. Platform 100 may be a framework on which applications may be run and may be part of the operations behind a website 10. Platform 100 may be a computing platform for structured data processing. Website 10 may be a collection of Web pages, images, videos or other digital assets that may be hosted on one or more web servers, usually accessible via the Internet.

Platform 100 may receive data from a user system 12, use that data in a workflow definition, and bundle that data with an application for batch use in a distributed computation environment 14 as part of executing the workflow definition. The bundled application (identified below as business logic application 214) may include code from a predefined template. The predefined template may minimize a need for users of platform 100 to understand either workflow definitions or distributed applications running on large clusters of commodity computers.

Structured data may include information organized to allow identification and separation of the context of the information from its content. Structured data may be data represented in a manner that allows computation with those data. This may include number and facts that may be stored and retrieved in an orderly manner for operations and decision-making. Structured data further may include data kept in an electronic record, where each piece of information may have an assigned format and meaning. Platform 100 may integrate a dynamic workflow orchestration and an on-demand batch computation system and utilize software and hardware computer technology to process structured data through platform 100.

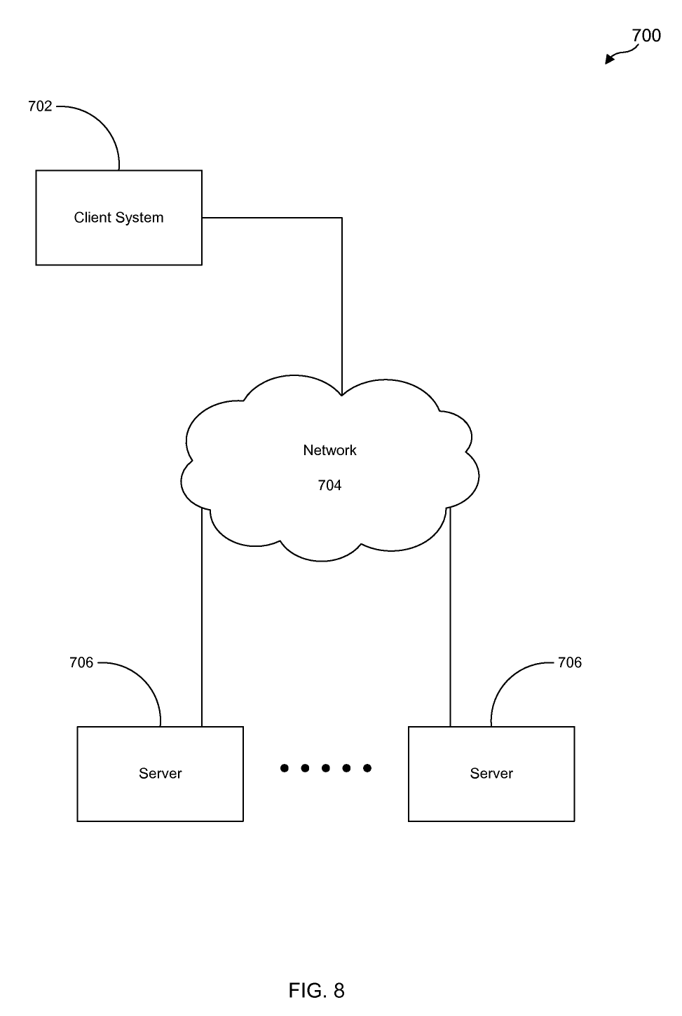

User system 12 may be a computer system remote from platform 100. A customer or user 16 of website 10 may operate user system 12. User system 12 may communicate with platform 100 over the Internet 704 (FIG. 8).

Distributed computation environment 14 may be a distributed file system that supports sharing of files, printers, and other resources as persistent storage over a computer network. Distributed computation environment 14 may include an external work scheduling software 18 in communication with a grid of connected computers 20.

User 16 may be someone who makes use of platform 100. User 16 may include a partner, an agent, a distributor, or an end user. User 16 may make use of platform 100 through user system 12.

External work scheduling software 18 may be employed for batch jobs. External work scheduling software 18 may be software positioned remote from platform 100 that may break big computing jobs into component tasks and distribute them across grid of connected computers 20, reallocating work when a server fails. In one example, external work scheduling software 18 may include Hadoop, a Free Java software framework developed by the Apache Software Foundation of Forest Hill, Md.

An on-demand batch computation system may process 1,000,000+ documents very quickly, for example, by breaking down the tasks into batch jobs. If the workflow definition needs to spell check the 1,000,000 documents, that task may be configured into a batch job to spell check each of the documents and return the results. The data that may be mapped across a large number of systems then may be retrieved and reduced back to the original documents. The results of the processing may be compiled into a report. The report and the original documents then may be sent back to the requester. With each computer 20 performing part of the batch job, the batch job may be completed in a timely manner.

To work properly, the work scheduling software should to receive both the data to be process and an application that instructs the work scheduling software on how to process the data. This may be done for each request made of the work scheduling software. Each request may incur a fee and these fees may add up overtime. Developing an application that instructs the work scheduling software on how to process the data requires detailed knowledge of the operations of the work scheduling software and the computer grid system over which it runs. Platform 100 may be configured to not require that users write new application for each change in the data, the computer grid system, and the work scheduling software.

Grid of connected computers 20 may include multiple independent computing clusters. The clusters may act like a “grid” because they may be composed of resource nodes not located within a single administrative domain. Grid of connected computers 20 may be a network of geographically dispersed computers.

Platform 100 may include a user system interface layer 200, component layer 300, and a management interface layer 400. User system interface layer 200 may be connected to component layer 300 and be configured to be connected to user system 12. Component layer 300 may be connected to management interface layer 400 and may be configured to be connected to external work scheduling software 18 and/or grid of connected computers 20.

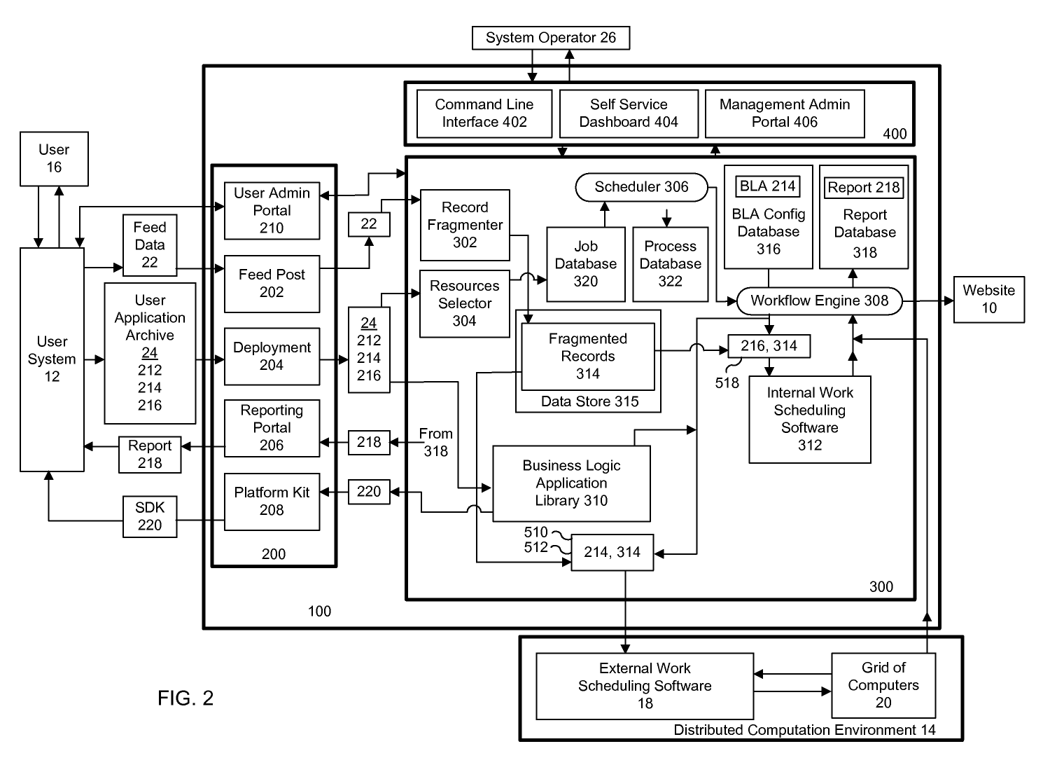

FIG. 2 is a block diagram illustrating details of platform 100. User system interface layer 200 may be a mechanism to allow user system 12 and platform 100 to communicate. User system interface layer 200 may include a feed post 202, a deployment 204, a reporting portal 206, a platform kit 208, and a user admin portal 210. Signals may be received in platform 100 from user system 12 through feed post 202, deployment 204, and user admin portal 210. Platform 100 may send signals to user system 12 through reporting portal 206, user admin portal 210, and platform kit 208.

Component layer 300 may contain core building blocks of platform 100. Component layer 300 may include may include at least one of an arithmetic and logic unit, a control unit, a memory, and an input and output device, each of which may be interconnected by a buss. In one example, component layer 300 may include a record fragmenter 302, a resources selector 304, a scheduler 306, a workflow engine 308, a business logic application library 310, and an internal work scheduling software 312.

Feed post 202 of user system interface layer 200 may receive feed data 22 from user system 12. Feed data 22 may include information desired by user system 12 to be processed by platform 100 and ultimately posted to website 10. For example, feed data 22 may include information about automobile listings, job postings, news feeds, and/or real estate listings. Formats for feed data 22 may range from Atom syndication format (ATOM) and comma-separated values (CSV) to tab-separated values (TSV) and the LDAP data interchange format (LDIF). Once feed data 22 is processed by platform 100, the now enriched data may make its way onto website 10.

Deployment 204 may receive a user application archive 24 from user system 12. User application archive 24 may include instructions from user system 12 on how to process feed data 22. These instructions may include a workflow definition 212, business logic applications 214, and user code 216. Workflow definition 212, business logic applications 214, and user code 216 each may be a functional implementation realized as software that may run in interplaying hardware entities.

Workflow definition 212 may be used by platform 100 to process feed data 22 according to predefined business processes. For example, in the case of real estate listings, platform 100 may send feed data 22 through a validation, filtering, and geocoding process contained within workflow definition 212. Workflow definition 212 (or workflow application 212) may tie together a bunch of business logic applications 214 to define a business flow.

Data received by platform 100 for posting on website 10 initially may be sent to workflow definition 212. Workflow definition 212 may process the data according to predefined business processes, such as by sending the data through a validation process, a filtering process, and a geocoding process. The process may include sequential operations, parallel flow of execution, and other forms of computation. A benefit of using workflow definition 212 is that the application logic may be changed to meet the ever-changing needs of platform 100.

In one example, workflow definition 212 may be developed through workflow models designed in a dedicated language that may be Extensible Markup Language (XML)-based, where tasks in these models may be linked to software applications for automated tasks. In another example, workflow definition 212 may be developed through a programming language in conjunction with Workflow Open Service Interface Definition or other library and interface that may capture abstractions for task coordination.

Business logic applications 214 may be one or more programs that may give distributed computation environment 14 and workflow engine 308 instructions to perform particular tasks on feed data 22. In one example, platform 100 may bundle business logic applications 214 to feed data 22 and send that bundle to external work scheduling software 18 for processing.

Platform 100 may be intimately aware of the workings of workflow definitions 212 and business logic applications 214. Platform 100 may utilize this knowledge to optimize the runtime. For example, without any intervention from user system 12, platform 100 may optimize the configuration to give a best performance or collapse similar jobs into one batch job. As an example, platform 100 may pipe together certain business logic applications 214. For example, spell check and data cleaning (removing extra spaces, commas, etc.) may be part of two separate business logic applications 214 that may be piped together as one batch job. The one batch job may be transmitted to external work scheduling software 18. External work scheduling software 18 may run the piped business logic applications 214 as one batch job. In this example, spell check may be run under a first business logic application 214 on a first listing and then data cleaning may be run under a second business logic application 214 on the first listing. An output then may be generated. Since external work scheduling software 18 may charge this as one batch job (rather than two jobs), this may reduce in/out overhead costs for platform 100.

Platform 100 may support session and header for every run of a workflow. This may be used as foundation to share and communicate between each business logic application 214. All information in the session may be available globally to all the business logic applications 214 in the workflow. After every invocation of a business logic application 214, platform 100 may persist session information and makes it available to every business logic application 214 via its interfaces.

User code 216 may provide instructions to platform 100 to select particular resources within platform 100 to process feed data 22. For example, user code 216 may instruct platform 100 on how to utilize workflow definition 212 and business logic applications 214 relative to the received feed data 22. In addition, user code 216 may instruct platform 100 to utilize preprogrammed workflow definitions and/or business logic applications stored within platform 100, such as may be stored in business logic application library 310.

Reporting portal 206 may send report output 218 to user system 12. Platform 100 may collect detailed metrics as the data is processed. Platform 100 then unify the details in one consolidated report 218. Report output 218 may be a statement containing an outcome of the processing of feed data 22 by workflow engine 308, distributed computation environment 14, and other processing systems of platform 100. This may allow user 16 to get significant insights into the processing that occurred. User 16 may configure user code 216 to instruct platform 100 on how to configure report output 218.

Platform kit 208 may send a software development kit (SDK) 220 to user system 12. Software development kit 220 may include one or more development tools that may allow a user to create workflow definitions 212, business logic applications 214, and other applications for use by platform 100 and use by external work scheduling software 18. Software development kit 220 may include enough information to allow a user to create applications for platform 100 and external work scheduling software 18 without a need to know the detailed workings of either platform 100 or external work scheduling software 18.

In regards to business logic applications 214 by platform kit 208, observations have shown that business logic applications 214 for processing may be divided into no more than four predefined code patterns: a record grouper, a record grouper processor, a header processor, and a record processor. The record grouper may include predetermined code that may group the records from feed post 22 into a format usable by platform 100. The record grouper processor may be code utilized to run the record grouper. Moreover, the header processor may be predetermined code to process feeder header 24.

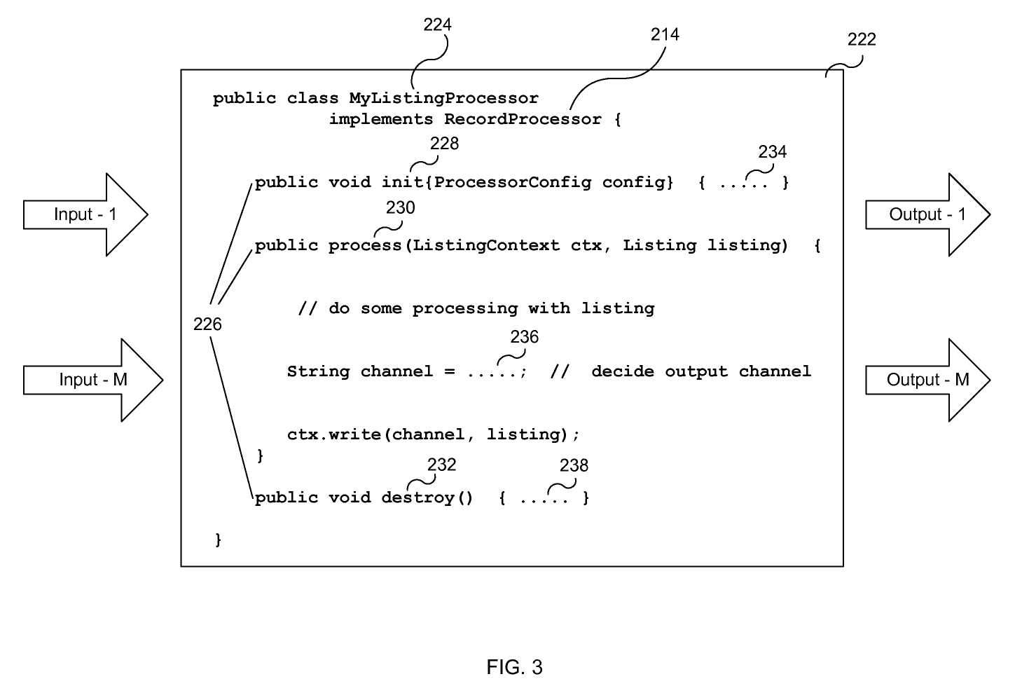

FIG. 3 is a template 222 for a record processor business logic application 214 written in Java programming language. An application programming interface (API) may include a source code interface that an operating system, library, or service may provide to support requests made by computer programs. Template 222 may be one of four APIs and include predefined code to be transmitted with platform kit 208 as a business logic application 214, where user 16 may fill in the blanks and return the completed business logic application 214 to platform 100 as part of user application archive 24. Platform 100 may bundle record processor business logic application 214 with feed post 22 and map the bundle to distributed computation environment 14 for processing. In one example, software development kit 220 may include a template 222 as a development tool to create a business logic application 214.

Template 222 may include a classname 224 and three interfaces 226, such as initiation (init) 228, process 230, and destroy 232. Each of the three interfaces 226 may be public and may include a space parameter where user 16 may have code and/or data particular to their needs passed and acted upon by template 222 to produce an output. Initiation (init) 228, process 230, and destroy 232 may include initiation code space 234, process code space 236, and destroy code space 238, respectively. The space where user 16 may have data passed is illustrated as “ . . . ” in FIG. 3. Code just after the “//” lines may be comments and brackets { } may enclose discrete code.

In this example, classname 224 may be “MyListingProcessor” such as might be utilized to process one batch job opening listing record, one real estate ad record, or one rental ad record, for example. The processing might be spell check, validate, geocode, resize image, archive, for example. The actual listing record may be input by user 16 in process code space 236 as a text string representative of rows and columns of data. Initiation 228 may initialize and allocate required resources. Process 230 may process the data. Destroy 232 may free up allocated resources.

One listing may be processed at a time. For example, distributed computation environment 14 may disburse Input-1 input channel into initiation code space 234, process code space 236, and destroy code space 238. That input may be processed to produce data reports Output-1 as an output channel. The process may be repeated for M inputs and M outputs.

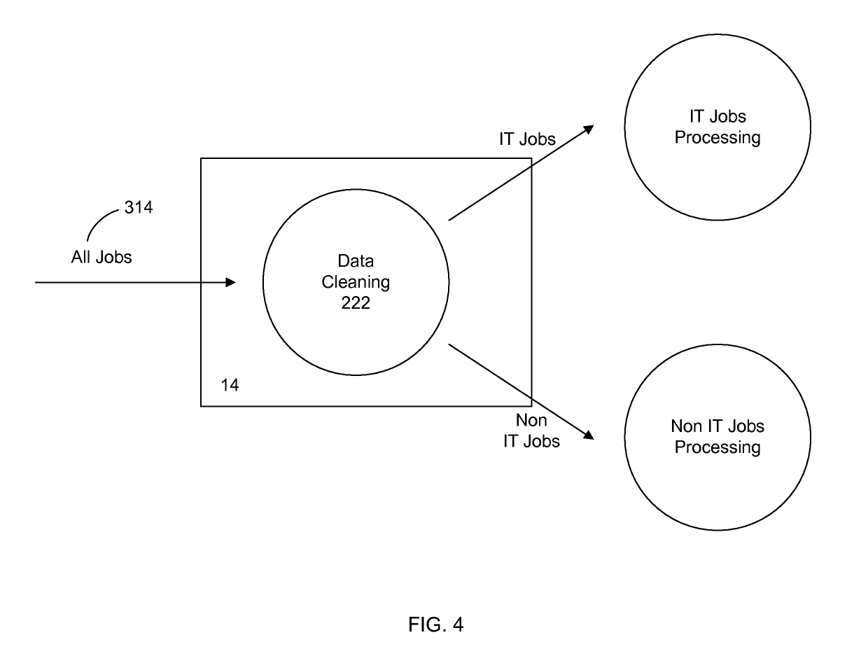

FIG. 4 is an example of distributed computation environment 14 processing a data cleaning template 222 into multiple outputs. Data cleaning template 222 may be a business logic application 214 configured to clean documents within fragmented records 314 of extra spaces, extra commas, etc. Template 222 may take in a set of input channels and deliver a set of output channels. Every channel may be named and declared explicitly. In addition, each piece of data that may be processed through template 222 by distributed computation environment 14 may be pushed to a specific channel. This may lay a foundation for data routing at the workflow level.

In FIG. 4, data cleaning template 222 may route the data 314 into two different channels after analyzing every job it receives as input 314. For example, data cleaning template 222 may receive all jobs and route the information technology (IT) jobs to IT jobs processing and the non-IT jobs to a non-IT jobs processing. Platform 100 makes this possible by overriding default aspects of distributed computation environment 14 to support multiple outputs per single distributed computation environment 14 job.

Platform kit 208 (FIG. 2) may include at least one predefined code pattern template interface from a group of four predefined code pattern template interfaces. Importantly, the four predefined code pattern templates to create business logic applications 214 do not require that user 16 know anything about a workflow process or a distributed computation environment. Here, the predefined code contained in template 222 (FIG. 3) and templates for the record grouper, the record grouper processor, and the header processor support processing any structured data in a native format. They may mitigate a need for user 16 to keep track of changes in work scheduling software 18 and computer grid system 20. The four templates substantially may be identical with an exception of the second line reading “implements RecordProcessor” in template 222. That line alternatively may read “implements RecordGrouper,” “implements RecordGroupProcessor,” and “implements HeaderProcessor.”

User admin portal 210 (FIG. 2) may be a mechanism for user 16 to administer core components layer 300 as it relates to user system 12. For example, user 16 may utilize user admin portal 210 to request a report 218 of events and situation other than as requested through deployment 204. Additionally, user 16 may utilize user admin portal 210 every three days, for example, to clean memory in portal 100 of feed data 22 from user system 12 or clean out temporary files created for user system 12. As another example, user 16 may instruct platform 100 to rerun one or more workflow definitions 212. User admin portal 210 may include a graphical user interface to aid in administering components layer 300 as it relates to user system 12.

As noted above, component layer 300 may include record fragmenter 302, resources selector 304, scheduler 306, workflow engine 308, business logic application library 310, and internal work scheduling software 312. Component layer 300 additionally may include a data store 315, a business logic application (BLA) configuration database 316, a report database 318, a job database 320, and a process database 322. Each of these items may be configured to be in communication with other elements of component layer 300.

Grid of computers 20 may require that any data received by grid of computers 20 be in a particular format. For example, if feed data 22 included 1,000,000 feeds, grid of computers 20 may need to know a beginning and end of the records and a boundary of each record. This may aid in unifying grid of computers 20.

Record fragmenter 302 of component layer 300 may receive feed data 22 as a full data feed from feed post 202 and may process feed data 22 into fragmented records 314 according to predetermined record boundary criteria. After feed data 22 passes through record fragmenter 302, the resulting fragmented records 314 may be semantically correct and understandable by distributed computation environment 14 and workflow engine 308. For example, if feed data 22 included 1,000,000 feeds, record fragmenter 302 may fragment the 1,000,000 feeds into multiple records having a predetermined configuration usable by grid of computers 20.

Fragmented records 314 may be stored in data store 315. In computing, a distributed file system may include a network file system where a single file system may be distributed across several physical computer nodes. Data store 315 may be part of distributed file system (DFS).

In an example, record fragmenter 302 may fragment the 1,000,000 feeds into multiple high priority records and multiple low priority records usable by two independent grids of computers 20: one for low priority records and one for high priority records. Additionally, platform 100 may bundle the business logic applications 214 to fragmented records 314 and send that bundle to external work scheduling software 18. Each configuration for business logic applications 214 from a particular user 16 may be stored in business logic applications configuration database 316 and in business logic applications library 310 within components layer 300.

Resources selector 304 may receive user application archive 24 and determine which of the resources of platform 100 may be allocated to process feed data 22. For example, resources selector 304 may determine what workflow definition will process feed data 22, what grids of computers 20 will process the data from the workflow definition, what partition will be utilized for feed data 22, what internal work scheduling software 312 will be utilized, and what logging files will be utilized. The resources selected may be a function of user code 216 from user system 12 and predetermined instructions from platform 100. Jobs from resources selector 304 may be stored in jobs database 320.

Scheduler 306 may be a system that may schedule processor time for each process to facilitate multitasking. Workflow definition 212 may include a series of time dependent processes. Moreover, platform 100 may receive numerous feed data 22 and user application archives 24 on increments of a tenth and hundredth of a second. Scheduler 306 may ensure that all processes of platform 100 can meet deadlines to keep the system stable.

Workflow engine 308 (or workflow executor 308) may be a software application to manage and execute modeled business processes, such as workflow definitions 212. Workflow engine 308 may interpret events such as documents submitted to platform 100 through feed data 22 or due dates expiring and act on these events according to defined business processes. In an example, workflow engine 308 may receive workflow definitions 212 from deployment 204 and process feed data 22 through workflow definitions 212. In one example, workflow engine 308 may be jBPM, a platform for executable process languages ranging from business process management (BPM) over workflow to service orchestration. To orchestrate a business flow using jBPM as workflow engine 308, jBPM may execute its own process definition language known as jPDL (JBoss Process Definition Language), both of which are manufactured in Atlanta, Ga. by the JBoss division of Red Hat, Inc. Data from jBPM such as job state may be stored in process database 322.

Business logic application library 310 may be a storage area for previously written business logic applications 214 and other applications that platform 100 may find useful. Observations have shown that distributed computation environment 14 utilizes many business logic applications 214 having substantially identical code. For example, a spell check request by a first user 16A may utilize substantially identical code as a spell check request by a second user 16B. Rather than require first user 16A and second user 16B to write separate business logic applications for their spell check request, first user 16A and second user 16B each may direct platform 100 to access the appropriate business logic applications 214 within business logic application library 310 for their separate spell check request. Examples of previously written business logic applications 214 may include authentication, categorization, creating catalogs, cross-referencing data, de-duping, Email, HTML cleanup, image processing, localization, normalization, & data cleansing, and validation.

Business logic application library 310 may receive new business logic applications 214 from each user system 16 and, over time, build up an accessible collection of business logic applications 214 that may mitigate a need for users 16 to write their own business logic applications 214. By compiling and storing already developed, reusable business logic applications that instructs external work scheduling software 18 on how to process the data over grid over computers 20, platform 100 may significantly reduce the very difficult and time consuming task of writing grid instruction applications.

Not all batch jobs require the processing power of grid of computers 20. Some batch jobs may be small, such as spell checking six pages contained in two records. Under such circumstances, it may be inefficient to send such a batch job to external work scheduling software 18. Internal work scheduling software 312 may be an in-memory executor utilized for small batch jobs and other low volume data feeds such as those that may be handled by a single desktop computer. Internal work scheduling software 312 may be connected to a grid of computers that may be internal to platform 100. Internal work scheduling software 312 may make use of geographically dispersed spare computing resources networked within an organization. In an example, internal work scheduling software 312 may utilize Apache Tomcat, a web container for workflow orchestration and online data processing manufactured by the Apache Software Foundation of Forest Hill, Md.

Management interface layer 400 (FIG. 2) may be a mechanism to allow a systems operator 26 to oversee the operations of platform 100. Management interface layer 400 may include a command line interface 402, a self-service dashboard 404, and a management admin portal 406.

Command line interface 402 may be a mechanism to allow a systems operator to interact with platform 100 by typing commands to conduct the system. After the systems operator presses enter, a command line interpreter then may receive, analyze, and launch the requested command. The command line interpreter may return an answer or operation summary output to the systems operator in the form of text lines. Alternatively, platform 100 may include a mouse pointer as part of a graphical user interface and menus as part of a text user interface.

Self-service dashboard 404 may display viewable images generated by platform 100 to allow a systems operator to see the progress of platform 100 and make decisions about that progress. For example, self-service dashboard 404 may display the amount of data platform 100 received from a particular user system 12, how much of the data has been processed, and an operation summary for each business logic used in processing that data. Here, self-service dashboard 404 may provide a visual display of what is going on within platform 100.

Management admin portal 406 may be a mechanism to administer core components layer 300 of platform 100. For example, a system operator may utilize management admin portal 406 to increase memory and make a process operate faster. Management admin portal 406 may include a graphical user interface to aid in administering platform 100.

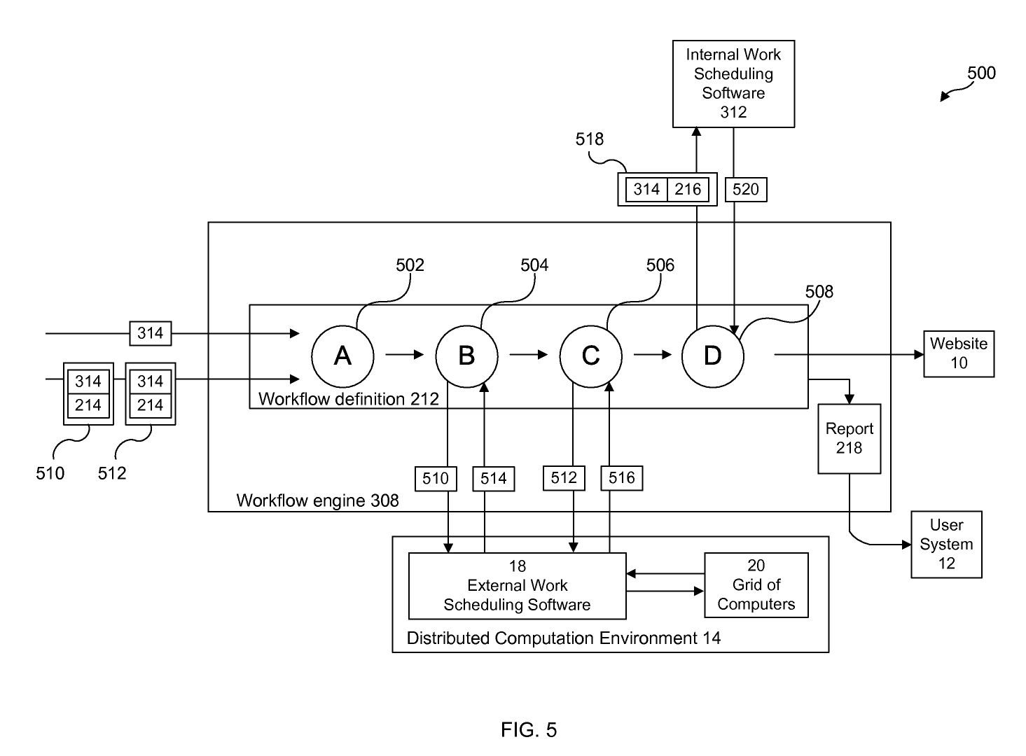

FIG. 5 is a schematic 500 of workflow definition 212 being executed by workflow engine 308. Workflow definition 212 may include a process A 502, a process B 504, a process C 506, and a process D 508. Workflow definition 212 may be viewed as a dynamic workflow orchestration. Platform 100 may bundle business logic applications 214 to fragmented records 314 as a feed bundle 510 and a feed bundle 512, for example. Feed bundle 512 may contain different business logic applications 214 from those contained in feed bundle 510. Workflow definition 212 may tie together a bunch of business logic applications 214 to define a business flow.

Platform 100 may send fragmented records 314, feed bundle 510, and feed bundle 512 into workflow definition 212 where process A 502, process B 504, process C 506, and process D 508 each may perform a particular operation on the data. For example, process A 502 may process fragmented records 314 into incremental feed.

Process B 504 may receive feed from process A 502 to validate the data. Certain aspects of validating data may be performed better as a batch job rather than a workflow job. To validate the data, platform 100 may send feed bundle 510 to grid of computers 20 through external work scheduling software 18. On receiving feed bundle 510, external work scheduling software 18 may use the received business logic applications 214 to process fragmented records 314 and return the results to process B 504 as a first grid output 514. Process B 504 may utilize first grid output 514 for further processing. The distribution of feed bundle 510 from process B 504 to external work scheduling software 18 and receipt of first grid output 514 by process B 504 may be viewed as a distributed batch job system or an on demand batch computation system.

Process C 506 may receive feed from process B 504 to geocode the data. A geocode (geospatial entity object code) is representation format of a geospatial coordinate measurement used to provide a standard representation of an exact geospatial point location at, below, above the surface of the earth at a specified moment of time. To geocode the data, platform 100 may employ a second distributed batch job system. For example, platform 100 may send feed bundle 512 to external work scheduling software 18 and receive back a second grid output 516. Process C 506 may utilize second grid output 516 for further processing.

Process D 508 may receive feed from process C506 and determine whether the data includes any HTTP 404 not found error messages. The 404/Not Found error message is an HTTP standard response code indicating that the client was able to communicate with the server but the server could not find what was requested, or it was configured not to fulfill the request and not reveal the reason why. In this example, there may be only five HTTP addresses contained within fragmented records 314 that need to be checked. Such a batch job may be too small to send economically through distributed computation environment 14. To HTTP 404 the data, platform 100 may employ a third distributed batch job system. Here, platform 100 may bundle user code 216 and fragmented records 314 into a feed bundle 518. Platform 100 may send feed bundle 518 to internal work scheduling software 312, and receive back a first internal output 520 for further processing by process D 508. An advantage of utilizing internal work scheduling software 312 is that the host of website 10 may keep the monetary fees typically paid by user 16 to the operators of distributed computation environment 14. Once platform 100 has walked the data through workflow definition 212, the resulting output may be sent to website 10 and a report 218 may be generated and sent to reporting database 318 within components layer 300. Report 218 then may be sent to user system 12 through reporting portal 206.

Platform 100 may utilize a workflow orchestration and a distributed batch job system. Platform 100 may utilize workflow definition 212 to interpret a business flow and orchestrate a graph appropriately while running the actual business logic applications 214 on distributed computation environment 14 such as external work scheduling software 18 and grid of computers 20. Platform 100 may abstract out the workflow as well as the distributed computation environment so that business logic applications 214 may be converted at runtime to a batch job compliant with external work scheduling software 18.

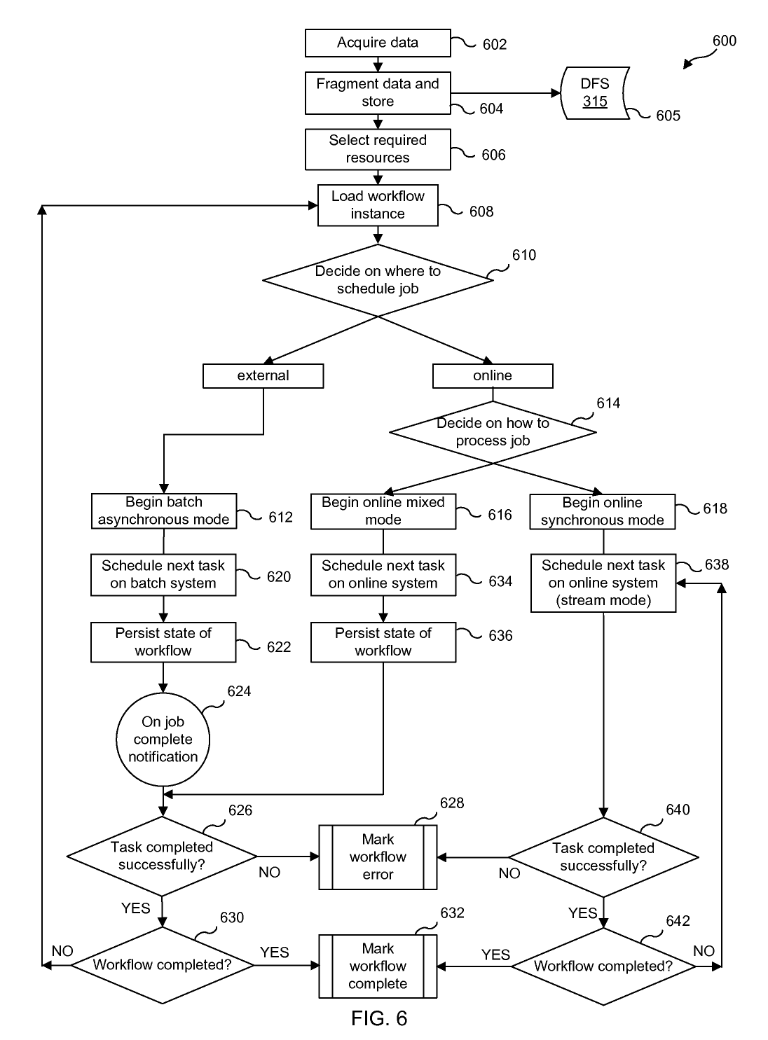

FIG. 6 is a data flow diagram illustrating a method 600 to record process data in workflow definition 212. At 602, platform 100 may acquire feed data 22 from user system 12. At 604, platform 100 may engage record fragmenter 302, fragment feed data 22 into fragmented records 314. Fragmented records 314 may be stored in data store 315 at step 605.

At 606, platform 100 may select those resources that may be required to process fragmented records 314. Platform 100 may have received workflow definitions 212 and business logic applications 214 from user system 12 as part of the resources that may be selected to process fragmented records 314. Additionally, platform 100 may have received user code 216 having instructions to select additional resources, such as those that may be stored within business logic application library 310.

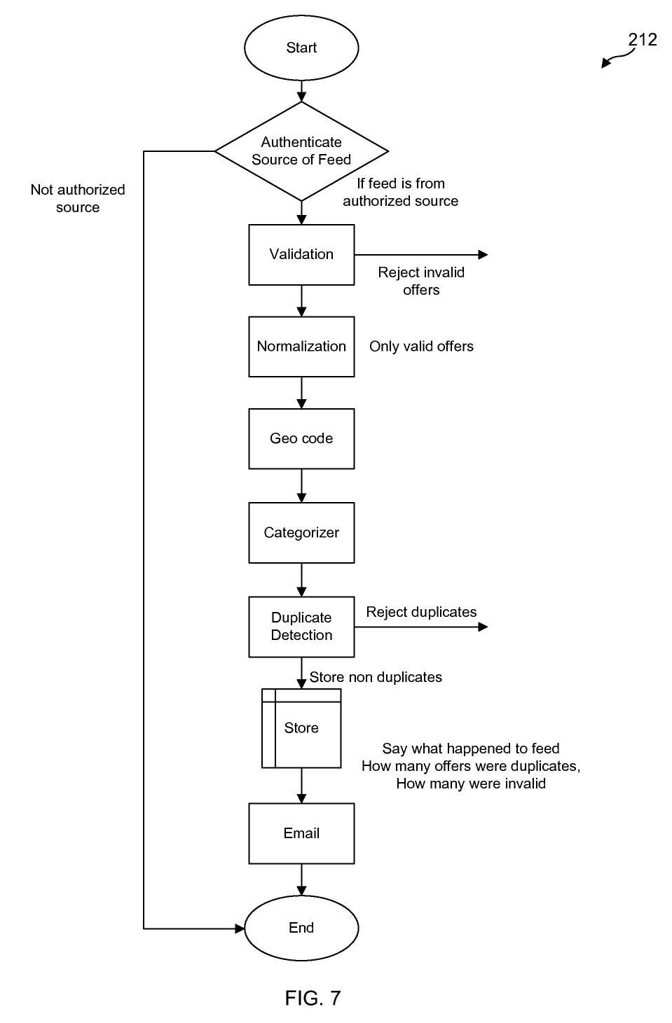

At 608, platform 100 may load a workflow definition 212 into workflow engine 308. FIG. 7 is an example workflow definition 212. Before posting the feed website 10, platform 100 may need to perform the tasks listed in FIG. 7 in a predefined sequence. Authentication may include checking on whether user system 12 may be authorized to supply feed data 22 into platform 100 and proceeding only if user system 12 has the right credential. Validation may validate various attributes of a record and ensure that all the mandatory attributes may be present. Normalization may include normalizing “$100” and “100 Dollars” to a common type before further processing. Geocoding may include calculating a proper zip code based on a text address if a record has any address (like store address, or individual address). Categorization may include mapping the record to proper a catalog so that search for each record may be more efficient. Duplicate detection may include determining whether a record already existing in the present system. Email may include sending notification back to user system 12 about what happened to each record while being processed by platform 100.

Example workflow definition 212 may be part of shopping offers feed received by platform 100 from large businesses, such as online auction and shopping website eBay Inc. or electronic commerce company Amazon.com, Inc. who may submit a Giga bytes feed. Alternatively, example workflow definition 212 may be part of shopping offers feed received by platform 100 from small vendors, who may submit a few offers to a hundred offers and up to 50,000 offers. Further, example workflow definition 212 may be part of a shopping offer feed received by platform 100 from an online user who submitted the single shopping offer through site xyz.com.

For the 50,000 bytes feed submission and the gigabytes feed submission, it may be desirable to use a distributed file system (DFS) as intermediate storage. The Giga bytes feed submission may be processed more efficiently if sent to distributed computation environment 14 whereas the 50K bytes feed submission may be processed more efficiently if retained within platform 100 and processed through internal work scheduling software 312. The single shopping offer through site xyz.com may be processed more efficiently if processed in memory rather than using a distributed file system as intermediate storage.

At 610, platform 100 may determine whether to schedule a job of the workflow within platform 100 or external to platform 100. Recall that distributed computation environment 14 may be positioned external to platform 100 and internal work scheduling software 312 may be positioned within platform 100. Positioned within platform 100 may mean that internal work scheduling software 312 and platform 100 may be located within a single administrative domain with internal work scheduling software 312 positioned inside platform 100, outside platform 100, or a combination of inside and outside of platform 100. Platform 100 may receive feed data 22 that may range from a few bytes, through kilobytes (KB), megabytes (MB, and gigabyte (GB) to terabytes (TB) and eventually yottabyte (YB) and may vary from a few records to millions of records. A decision to process the data online within platform 100 or externally to platform 100 may be a function of the number of records submitted within feed data 22 and the size of feed data 22.

If platform 100 decides to schedule a job of the workflow external to platform 100, method 600 may proceed to step 612. At 612, method 600 may begin batch asynchronous mode. If platform 100 decides to schedule a job of the workflow within platform 100, method 600 may proceed to step 614.

A determination at step 610 to schedule a job of the workflow within platform 100 or external to platform 100 may be a function of an expression based intelligence to schedule a job in a batch system (e.g., distributed computation environment 14) or an online system (e.g., internal work scheduling software 312). For example, platform 100 may decide schedule a job on distributed computation environment 14 if the input feed size is greater than 1 MB. In addition, platform 100 may decide to schedule a job on internal work scheduling software 312 if the number of records in feed data 22 is less than five records.

If number of feeds to process are in web scale (i.e. 100K < > millions of request), then it may be desirable to schedule the job in distributed computation environment 14 rather than internal work scheduling software 312. Persisting helps achieve better reliability. However, using intermediate storage (distributed file system) to store data on a persistent disk between two job executions may become a major bottleneck and measurable overhead for internal work scheduling software 312 for feeds that are in web scale.

At 614, platform 100 may determine whether to process the online job in mixed mode or synchronous mode. Mixed mode may work in one of two modes: a distributed file mode and synchronously in a stream mode. If platform 100 decides to process the job in online mixed mode, method 600 may proceed to step 616 where method 600 may begin online mixed mode. If platform 100 decides to process the job synchronously, method 600 may proceed to step 618 where method 600 may begin online synchronous mode. Conditional operations may be performed asynchronously and plain sequence operations may be performed synchronously. A decision to process the asynchronously or synchronously may be a function of whether the operations to be performed may be conditional in nature in that some operations may be performed only if certain conditions are satisfied.

Table 1 below is an ordered arrangement of rows and columns, where the row headers may characterize the relative number of records submitted within feed data 22 and the column headers may characterize the relative size of each record within feed data 22:

TABLE 1

| | Small feed | Medium | Large feed |
|---|---|---|---|
| | data 22 | feed data | data 22 |
| | (<~KB) | 22 (Few ~KB) | (MBs to GBs) |
| Small number of records | Online | | |
| (<~100) | synchronous | | |
| | mode 618 | | |
| Medium number of | | | Batch |
| records (~100 to 50,000) | | | asynchronous |
| | | | mode 612 |
| Large number of records | | Online mixed | |
| (>~50,000) | | mode 616 | |

Feeds measuring in megabytes (MBs) to gigabytes (GBs) may be run in batch asynchronous mode 612. Large number of feeds from small vendors and partners may be run in online mixed mode 616. Further, web user submission data may be run in online synchronous mode 618.

At present, a small number of records may be less than 100 records (e.g., an online user submitting one shopping offer record through site xyz.com). A medium number of records may be between 100 and 50,000 records (e.g., shopping offers submitted by small vendors, shops, etc., may be few to hundred offers per submission, but the number of submission may go up to ˜50K). Further, a large number of records may be greater than 50,000, such as up to 1,000,000 records or more. The relative size of each record within that data set may range from small (less than a kilobyte), medium (kilobyte and megabyte size), and large (greater than a few gigabytes).

Using a system external to platform 100 (such as distributed computation environment 14) may come with overhead in the form of data in/out (IO) overhead, forking processes in each node, copying data to a distributed file system, and other distributed job scheduling overhead. This overhead may be justified where the power of grid of computers 20 may be needed to process a job on time, such as for a medium number of records (˜1,000 records), where in each record may contain a large data set (˜a few gigabytes). In general, a batch orientated system may be more efficient with large data. However, where there are a large number of records (˜100,000 records) and each record contains smaller data set (˜a few KBs), the overhead of using distributed computation environment 14 may be significant and it may be more economical and efficient to process the jobs within platform 100.

What is considered a small, medium, or larger may be relative and may change over time. As technology improves, more jobs may be processed within platform 100. Where a few GBs now may be considered a large size of each record within that data set, that minimum may be raised to terabyte and petabyte in the future so that more jobs may be process within platform 100.

In a synchronous system, operations may be coordinated under the centralized control of a fixed-rate global clock signal or several clocks. Scheduler 306 may supply such signals. An asynchronous system, in contrast, may lack a global clock. Instead, an asynchronous system may operate under distributed control, with concurrent hardware components communicating and synchronizing on channels. The parts of an asynchronous system need only wait for the signals that indicate completion of instructions and operations.

A synchronous system may be desirable for plain sequence operations, where the amount of time needed to run the job is short. An asynchronous system may be desirable where the operations to be performed may be conditional in nature in that some operations may be performed only if certain conditions are satisfied. Batch jobs typically are long running jobs and an asynchronous workflow execution may provide better reliability and efficient usage of resources.

To allow a process to be asynchronous, there may need to be some form of intermediate memory queue, such as a distributed file system, to hold pending requests, and each step of the process communicates with these intermediate queues instead of directly with the previous or next step. Here, asynchronous mode may include saving (persisting) and reloading the state of the workflow instance between every record job execution.

Batch Asynchronous Mode 612

For batch asynchronous mode 612, a job may be scheduled on a batch system in asynchronous mode. An asynchronous mode may include saving and reloading workflow instance between every job execution.

Method 600 may begin batch asynchronous mode 612 at step 612 and proceed to step 620. At step 620 in FIG. 6, platform 100 may schedule the next task on a batch system. Distributed computation environment 14 is an example of a batch system. At step 622, platform 100 may persist the state of the workflow. This may include maintaining the workflow across session boundaries, usually in nonvolatile storage such distributed file system 315. For example, data may be read at step 620 from distributed file system 315, business logic application 214 may be processed on that data, and that data may be persisted back to distributed file system 315. Persisting helps achieve better reliability.

At step 624, platform 100 may inspect a quality of the product returned from distributed computation environment 14 and send out an on job complete notification. At step 626, platform 100 may determine whether the task was completed successfully. If the task was not completed successfully, method 600 may go to step 628, where platform 100 may engage a subroutine to mark workflow error.

If the task was completed successfully, method 600 may go to step 630. At step 630, platform 100 may determine whether the workflow is completed. If the workflow is not completed, method 600 may return to step 608. If the workflow is completed, method 600 may proceed to step 632. At step 632, platform 100 may engage a subroutine to mark workflow completed.

Online Mixed Mode 616

Method 600 may begin online mixed mode 616 at step 616 and proceed to step 634. At step 634 in FIG. 6, platform 100 may schedule the next task on an online system, such as internal work scheduling software 312. At step 636, platform 100 may persist the state of the workflow. After persisting the state of the workflow at step 636, method 600 may go to step 626.

Persisting the state of the workflow at step 636 may include reading data from distributed file system 315, processing business logic application 214 on that data, and persist that data back to distributed file system 315. Alternatively, this may include receiving data as payload of a web service, executing the processing unit like a batch job, and returning the processed data back as payload.

Online mixed mode 616 may simulate the behavior of a batch job execution within a single thread. Online mixed mode 616 may work in one of two modes: a distributed file mode and synchronously in a stream mode. In the distributed file mode, online mixed mode 616 may read data from a distributed file system, such as distributed file system 315. Online mixed mode 616 then may execute the processing unit like a batch job, and write data back to distributed file system after processing that data. In the stream mode, online mixed mode 616 may receive data as payload of a web service, execute the processing unit like a batch job, and return the processed data back as payload without persisting the state of the workflow.

Online mixed mode 616 further may implement a custom class loader as an internal. The custom class loader may maintain instance of a class loader for each application running on top of the online component. In addition, the custom class loader may dynamically load the required binaries for the each application. Online mixed mode 616 may caches the class loader. Further, online mixed mode 616 may optimizes the time takes to load the binaries. For example, online mixed mode 616 may loads all the binaries only when online mixed mode 616 receives a first request for an application. Subsequently, online mixed mode 616 may utilize the cached class loader to execute processing units to optimize the time takes to load the binaries.

As describe in connection with FIG. 3, a batch job may include three phases: initiation 228, process 230, and destroy 232. For small feed, initiation 228 and destroy 232 may become significant overhead. Here, online mixed mode 616 as a processing unit may perform initiation 228 only on receiving a first request. Only on requests made after the first request may online mixed mode 616 perform process 230. When the application is undeployed, online mixed mode 616 may perform destroy 232.

As noted above, the online component internal work scheduling software 312 may run in Distributed File System Mode. For example, when business logic application 214 executes on internal work scheduling software 312, internal work scheduling software 312 may read data from distributed file system 315, process business logic application 214 on the data and, after processing, persist that data back to the distributed file system 315. Since distributed file system 315 may be a common storage for batch asynchronous mode 612 and online mixed mode 616, business logic application 214 may be interleave both as a batch mode business logic application 214 and as an online mode business logic application 214 within same workflow.

Utilizing batch asynchronous mode 612 and online mixed mode 616 for the same workflow gives significantly better scalability compared to utilizing only batch asynchronous mode 612. In addition, this multiple workflow executor may provide the same level of reliability features as batch asynchronous mode 612 by itself while offering a way to process large number (i.e. around 50K to 100K feeds) of medium feeds (through online mixed mode 616) and medium numbers of large feeds (few ˜GB) (through batch asynchronous mode 612).

Online Synchronous Mode 618

Method 600 may begin online synchronous mode 618 at step 618 and proceed to step 638. At step 638, platform 100 may schedule the next task on an online system, such as internal work scheduling software 312. This may be done in stream mode. In the stream mode, online synchronous mode 618 may receive data as HTTP payload of a web service, execute the processing unit like a batch job, and return the processed data back as payload.

At step 640, platform 100 may determine whether the task was completed successfully. If the task was not completed successfully, method 600 may go to step 628, where platform 100 may engage a subroutine to mark workflow error.

If the task was completed successfully, method 600 may go to step 642. At step 642, platform 100 may determine whether the workflow is completed. If the workflow is not completed, method 600 may return to step 638. If the workflow is completed, method 600 may proceed to step 632. At step 632, platform 100 may engage a subroutine to mark workflow completed.

Using a synchronous mode for the online component as a base feature, the complete workflow execution may be processed in memory and made synchronous. This helps avoid using distributed file system 315 as intermediate storage. An advantage of this approach is that it permits processing small amounts of data and get sub seconds level responses.

As an example, if an online user submits one shopping offer through site xyz.com, that user may receive a HTTP success response at step 632 if the shopping offer is accepted for posting on website 10. That user may receive an HTTP error from step 628 if there is failure in processing. The user may resubmit the shopping offer in case of failures.

FIG. 8 illustrates a network environment 700 for operation of the platform 100. The network environment 700 may include a client system 702 coupled to a network 704 (such as the Internet, an intranet, an extranet, a virtual private network, a non-TCP/IP based network, any LAN or WAN, or the like) and server systems 706₁ to 706_{N}. A server system may include a single server computer or a number of server computers. Client system 702 may be configured to communicate with any of server systems 706₁ to 706_{N}, for example, to request and receive base content and additional content (e.g., in the form of photographs).

Client system 702 may include a desktop personal computer, workstation, laptop, PDA, cell phone, any wireless application protocol (WAP) enabled device, or any other device capable of communicating directly or indirectly to a network. Client system 702 typically may run a web-browsing program that may allow a user of client system 702 to request and receive content from server systems 706₁ to 706_{N} over network 704. Client system 702 may one or more user interface devices (such as a keyboard, a mouse, a roller ball, a touch screen, a pen or the like) to interact with a graphical user interface (GUI) of the web browser on a display (e.g., monitor screen, LCD display, etc.).

In some embodiments, client system 702 and/or system servers 706₁ to 706_{N} may be configured to perform the methods described herein. The methods of some embodiments may be implemented in software or hardware configured to optimize the selection of additional content to be displayed to a user.

The information disclosed herein is provided merely to illustrate principles and should not be construed as limiting the scope of the subject matter of the terms of the claims. The written specification and figures are, accordingly, to be regarded in an illustrative rather than a restrictive sense. Moreover, the principles disclosed may be applied to achieve the advantages described herein and to achieve other advantages or to satisfy other objectives, as well.

What is claimed is:

1. A computing platform to process structured data, the computing platform comprising:
a component layer having a workflow engine to execute a workflow definition, where the workflow engine is configured to receive feed data from a user system, and where the workflow engine is configured to send a business logic application and feed data to a distributed computation environment to batch process the feed data through the business logic application as part of executing the workflow definition.

2. The computing platform of claim 1, further comprising:
a user system interface layer connected to the component layer, where the component layer includes an internal work scheduling software and where the workflow engine is configured to send a business logic application and feed data to the internal work scheduling software to process the feed data through the business logic application as part of executing the workflow definition.

3. The computing platform of claim 2, where the user system interface layer includes at least one of a feed post, a deployment, a reporting portal, a platform kit, and a user admin portal, where the deployment is configured to receive a workflow definition and a business logic application from the user system.

4. The computing platform of claim 3, where the deployment is configured to receive user code from the user system, where the user code includes instructions to select particular resources within the computing platform to process the feed data.

5. The computing platform of claim 4, where the component layer includes a business logic application library and a resources selector, where the user code includes instructions that cause the resources selector to select a business logic application from the business logic application library.

6. The computing platform of claim 5, where the business logic application library includes at least one business logic application received from the user system.

7. The computing platform of claim 2, where the component layer includes two business logic applications piped together as part of one batch job.

8. The computing platform of claim 1, further comprising:
a template for a business logic application.

9. The computing platform of claim 8, where the template for the business logic application includes only three interfaces from the group consisting of initiation, process, and destroy.

10. The computing platform of claim 8, where the template is configured to cause the distributed computation environment to route data into two different channels.

11. A method to process structured data in a computing platform, the method comprising:
receiving a workflow definition and feed data in a workflow engine, where the workflow engine is part of a component layer of the computer platform;
determining whether to execute the feed data in a batch asynchronous mode; and
sending the business logic application and feed data from the component layer to a distributed computation environment if it is determine that the feed data is to be executed in the batch asynchronous mode.

12. The method of claim 11, further comprising:
determining whether to execute the feed data in at least one of a batch asynchronous mode and an online mixed mode; and
sending the business logic application and feed data from the component layer to an internal work scheduling software positioned inside the computing platform if it is determine that the feed data is to be executed in the online mixed mode.

13. The method of claim 11, further comprising:
determining whether to execute the feed data in at least one of a batch asynchronous mode, an online mixed mode, and an online synchronous mode; and
sending the business logic application and feed data from the component layer to an internal work scheduling software positioned inside the computing platform if it is determine that the feed data is to be executed in the online synchronous mode.

14. The method of claim 13, where determining whether to execute the feed data in at least one of a batch asynchronous mode, an online mixed mode, and an online synchronous mode is a function of at least one of the number of records submitted within the feed data and the size the records within the feed data.

15. The method of claim 11, further comprising:
receiving at least one of a workflow definition and a business logic application in a user system interface layer of the computing platform;
receiving user code in a user system interface layer of the computing platform, where the user code includes instructions to select a business logic application from within the computing platform to process the feed data; and
piping together two business logic applications as part of one batch job.

16. The method of claim 11, further comprising:
sending a template to the distributed computation environment, where the template is configured to cause the distributed computation environment to route data into two different channels.

17. The method of claim 11, further comprising:
determining whether to sending the business logic application and feed data to one of the distributed computation environment and the internal work scheduling software as a function of at least one of the number of records within the feed data and the byte size of the feed data.

18. A computer readable medium comprising a set of instructions which, when executed by a computer, cause the computer to process structured data in a computing platform, the instructions for:
receiving a workflow definition and feed data in a workflow engine, where the workflow engine is part of a component layer of the computer platform;
determining whether to execute the feed data in a batch asynchronous mode; and
sending the business logic application and feed data from the component layer to a distributed computation environment if it is determine that the feed data is to be executed in the batch asynchronous mode.

19. The computer readable medium of claim 18, the instructions further comprising:
determining whether to execute the feed data in at least one of a batch asynchronous mode and an online mixed mode; and
sending the business logic application and feed data from the component layer to an internal work scheduling software positioned inside the computing platform if it is determine that the feed data is to be executed in the online mixed mode.

20. The computer readable medium of claim 18, the instructions further comprising:
determining whether to execute the feed data in at least one of a batch asynchronous mode, an online mixed mode, and an online synchronous mode; and
sending the business logic application and feed data from the component layer to an internal work scheduling software positioned inside the computing platform if it is determine that the feed data is to be executed in the online synchronous mode.

21. The computer readable medium of claim 20, where determining whether to execute the feed data in at least one of a batch asynchronous mode, an online mixed mode, and an online synchronous mode is a function of at least one of the number of records submitted within the feed data and the size the records within the feed data.

22. The computer readable medium of claim 18, the instructions further comprising:
receiving at least one of a workflow definition and a business logic application in a user system interface layer of the computing platform;
receiving user code in a user system interface layer of the computing platform, where the user code includes instructions to select a business logic application from within the computing platform to process the feed data; and
piping together two business logic applications as part of one batch job.

23. The computer readable medium of claim 18, the instructions further comprising:
sending a template to the distributed computation environment, where the template is configured to cause the distributed computation environment to route data into two different channels.

24. The computer readable medium of claim 18, the instructions further comprising:
determining whether to sending the business logic application and feed data to one of the distributed computation environment and the internal work scheduling software as a function of at least one of the number of records within the feed data and the byte size of the feed data.
